(19) United States
(12) Patent Application Publication
(10) Pub. No.: US 2016/0342111 A1
(43) Pub. Date: Nov. 24, 2016

(54) POWDER CONTAINER, IMAGE FORMING APPARATUS, AND TRANSPORT MEMBER DISPOSED THEREIN

(71) Applicant: FUJI XEROX CO., LTD., Tokyo (JP)

(72) Inventors: Yasunori Uemura, Kanagawa (JP); Masato Abe, Kanagawa (JP); Takayoshi Yamashita, Kanagawa (JP); Takuji Matsumoto, Kanagawa (JP); Yuki Terakado, Kanagawa (JP); Atsushi Sasaki, Kanagawa (JP)

(73) Assignee: FUJI XEROX CO., LTD., Tokyo (JP)

(21) Appl. No.: 14/980,868

(22) Filed: Dec. 28, 2015

(30) Foreign Application Priority Data
May 22, 2015 (JP) 2015-104564

(51) Int. Cl. G03G 15/08

(52) U.S. Cl. CPC G03G 15/0891

(57) ABSTRACT

A transport member includes a shaft portion that extends in one direction and that is disposed in a containing portion, which has a substantially columnar shape extending in the one direction and contains a powder, and a blade portion that includes a body portion having a substantially plate-like shape and a protruding portion having a plate thickness smaller than a plate thickness of the body portion, the body portion having a proximal end, which is fixed to the shaft portion, and a distal end, which is bent by coming into contact with an inner wall of the containing portion, and the protruding portion protruding from the distal end of the body portion.

### CROSS-REFERENCE TO RELATED APPLICATIONS

This application is based on and claims priority under 35 USC 119 from Japanese Patent Application No. 2015-104564 filed May 22, 2015.

### BACKGROUND

### Technical Field

The present invention relates to a transport member, a powder container, and an image forming apparatus.

### SUMMARY

According to an aspect of the invention, there is provided a transport member including a shaft portion that extends in one direction and that is disposed in a containing portion, which has a substantially columnar shape extending in the one direction and contains a powder, and a blade portion that includes a body portion having a substantially plate-like shape and a protruding portion having a plate thickness smaller than a plate thickness of the body portion, the body portion having a proximal end, which is fixed to the shaft portion, and a distal end, which is bent by coming into contact with an inner wall of the containing portion, and the protruding portion protruding from the distal end of the body portion.

### BRIEF DESCRIPTION OF THE DRAWINGS

An exemplary embodiment of the present invention will be described in detail based on the following figures, wherein:

FIGS. 1A, 1B, 1C, and 1D are respectively a front view illustrating a transport member according to an exemplary embodiment of the present invention, a cross-sectional view of the transport member, an enlarged front view of the transport member, and an enlarged cross-sectional view of the transport member;

FIGS. 2A and 2B are respectively a cross-sectional view and an enlarged cross-sectional view each illustrating a powder container according to the exemplary embodiment of the present invention;

FIG. 3 is an exploded perspective view illustrating the powder container according to the exemplary embodiment of the present invention;

FIG. 4 is an exploded view illustrating the powder container according to the exemplary embodiment of the present invention;

FIG. 5 is a sectional view illustrating the powder container according to the exemplary embodiment of the present invention; and

FIG. 6 is a schematic diagram illustrating an image forming apparatus according to the exemplary embodiment of the present invention.

### DETAILED DESCRIPTION

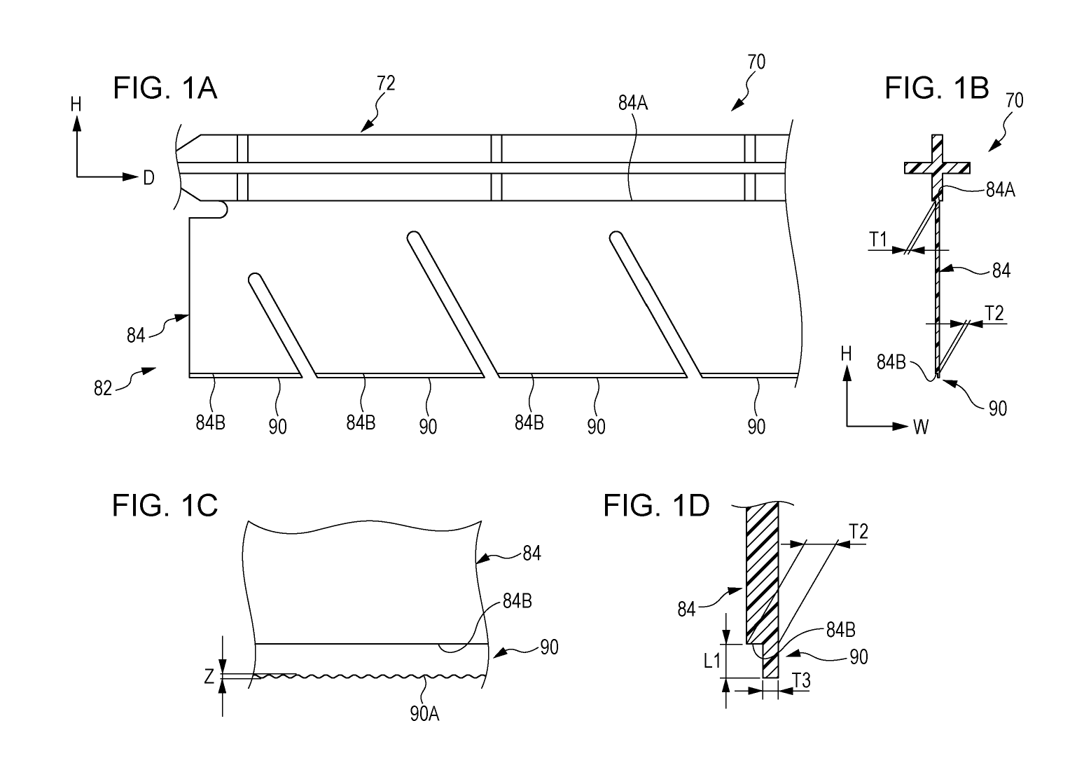

An example of each of a transport member, a powder container, and an image forming apparatus according to an exemplary embodiment of the present invention will be described with reference to FIG. 1A to FIG. 6. Note that, in each of the drawings, the direction of arrow H is the vertical direction and a height direction of the image forming apparatus (hereinafter referred to as “apparatus height direction”), the direction of arrow W is the horizontal direction and a width direction of the image forming apparatus (hereinafter referred to as “apparatus width direction”), and the direction of arrow D is the horizontal direction and a depth direction of the image forming apparatus (hereinafter referred to as “apparatus depth direction”).

### (Overall Configuration)

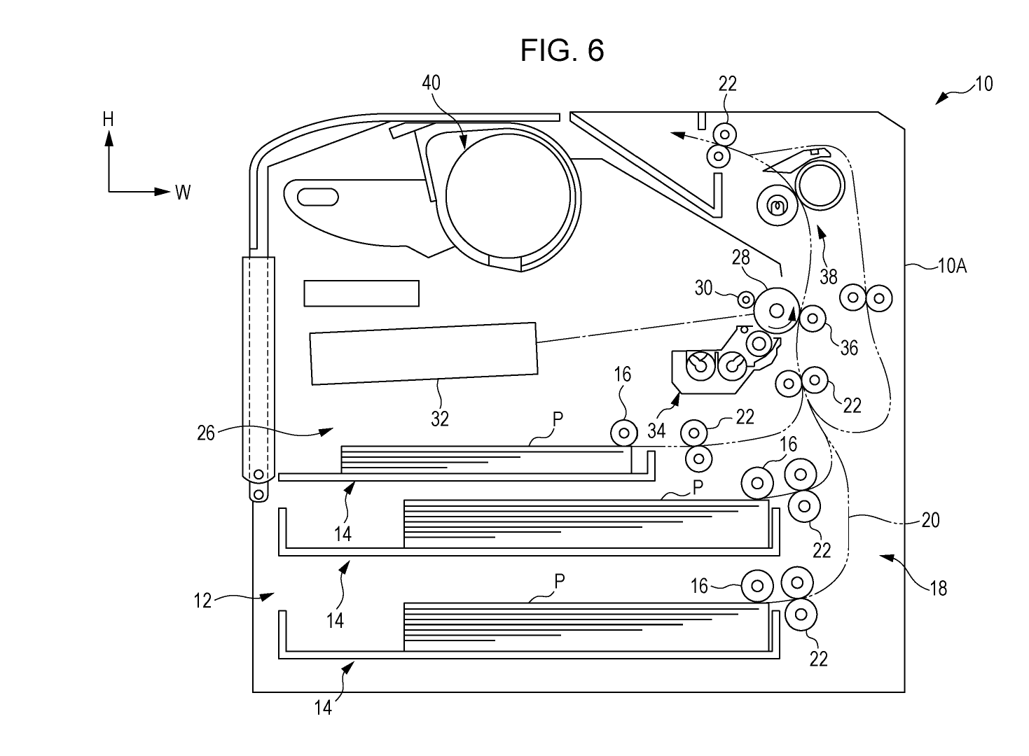

As illustrated in FIG. 6, an image forming apparatus 10 includes an accommodating unit 12 in which sheet members P, each of which serves as a recording medium, are accommodated, a transport unit 18 that transports the sheet members P along a transport path 20 of the sheet members P, and an image forming unit 26 that performs image formation on the sheet members P, which are transported.

### [Accommodating Unit]

The accommodating unit 12 includes plural accommodating members 14 in each of which the sheet members P are stacked and delivery rollers 16 that send out the sheet members P, which are stacked in the accommodating members 14, to the transport path 20.

### [Transport Unit]

The transport unit 18 includes plural transport rollers 22 each of which transports one of the sheet members P, which has been sent to the transport path 20 by a corresponding one of the delivery rollers 16, to a position downstream in a direction in which the sheet members P are to be transported.

### [Image Forming Unit]

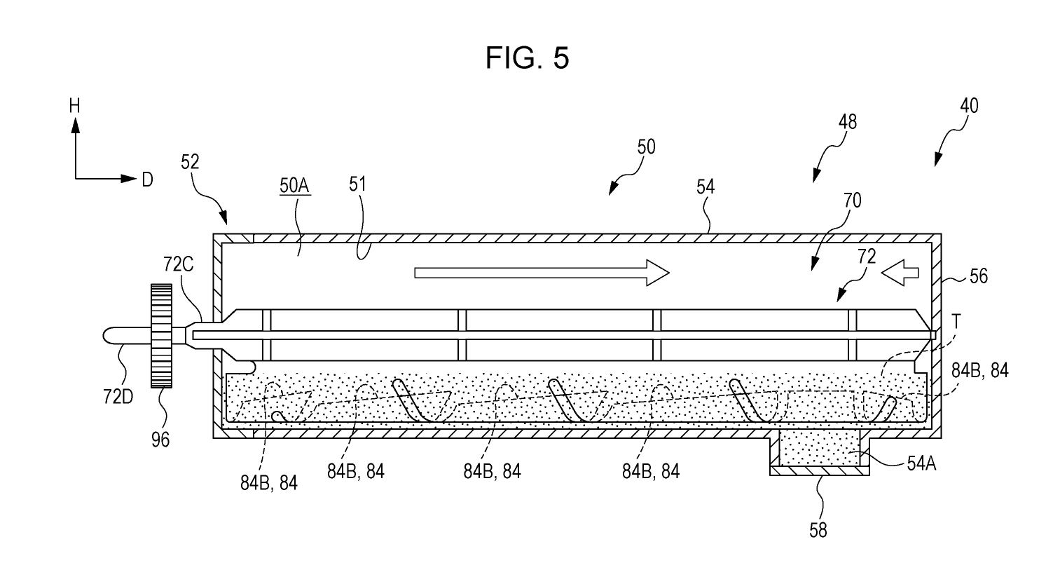

The image forming unit 26 includes an image carrier 28, a charging roller 30 that charges a surface of the image carrier 28, an exposure device 32 that exposes the charged surface of the image carrier 28 to exposure light in such a manner as to form an electrostatic latent image, and a developing device 34 that develops the electrostatic latent image by using a toner T (see FIG. 5), which is an example of a powder, so as to visualize the electrostatic latent image as a toner image.

In addition, the image forming unit 26 includes a transfer roller 36 that transfers the toner image, which has been formed on the surface of the image carrier 28, onto one of the sheet members P that is transported along the transport path 20 and a fixing device 38 that fixes the toner image on the sheet member P onto the sheet member P by applying heat and pressure to the toner image.

Furthermore, the image forming unit 26 includes a powder container 40 that includes a containing member 48 (see FIG. 5) in which the toner T, which is to be supplied to the developing device 34, is contained. The powder container 40 is removable from an apparatus body 10A of the image forming apparatus 10. Note that details of the powder container 40 will be described later.

### (Effects of Overall Configuration)

In the image forming apparatus 10, an image is formed in the following manner.

First, the charging roller 30, to which a voltage has been applied, uniformly charges the surface of the image carrier 28 to a predetermined potential. Next, the exposure device 32 radiates, on the basis of data input from the outside, the exposure light onto the surface of the image carrier 28, which has been charged, in such a manner as to form an electrostatic latent image.

As a result, an electrostatic latent image corresponding to image data is formed on the surface of the image carrier 28. Then, the developing device 34 develops the electrostatic latent image and visualizes the electrostatic latent image as a toner image.

The image carrier 28 and the transfer roller 36 transport one of the sheet members P, which is sent to the transport path 20 from one of the accommodating members 14 by the corresponding delivery roller 16 and transported by some of the transport rollers 22, by nipping the sheet member P therebetween. As a result, the transfer roller 36 transfers the toner image, which has been formed on the surface of the image carrier 28, onto the sheet member P.

Subsequently, the fixing device 38 fixes the toner image, which has been transferred to the sheet member P, onto the sheet member P. After that, the transport rollers 22 eject the sheet member P, which has the toner image fixed on its surface, to outside the image forming apparatus 10.

### (Configuration of Principal Portion)

The powder container 40 will now be described.

As illustrated in FIG. 6, the powder container 40 is disposed in an upper portion of the apparatus body 10A and is removable from the apparatus body 10A via the near side in the apparatus depth direction (the front side as viewed in FIG. 6).

As illustrated in FIG. 5, the powder container 40 includes the containing member 48 that contains the toner T, and a transport member 70 that is disposed in the containing member 48 and that transports the toner T, which is contained in the containing member 48.

### [Containing Member]

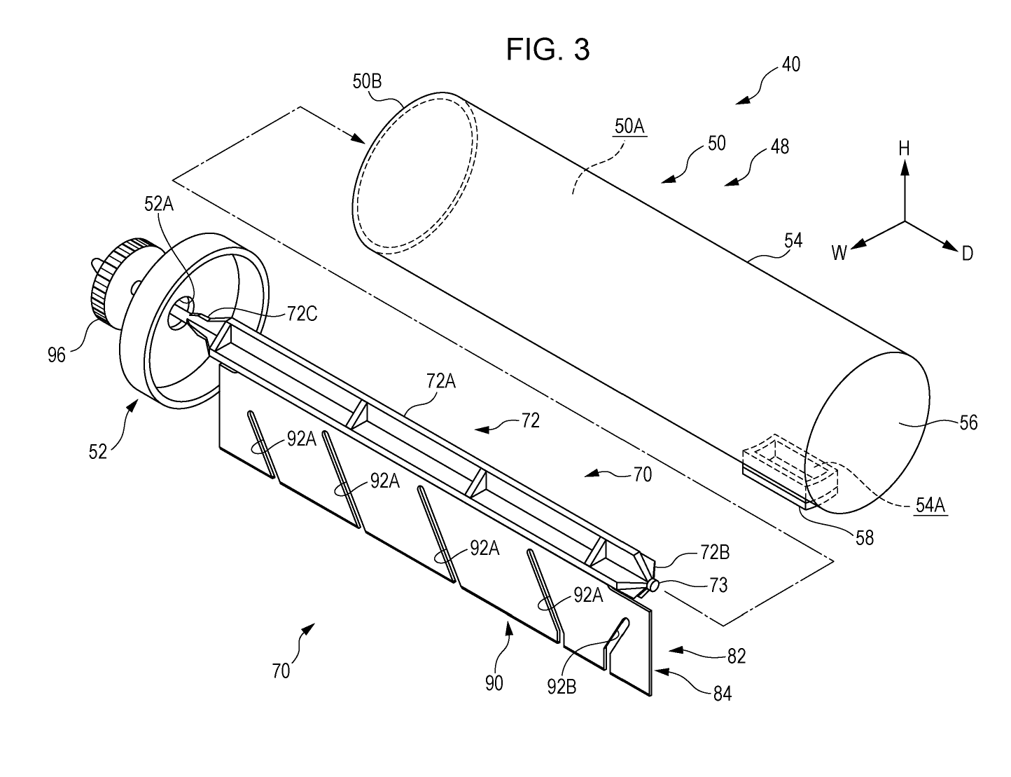

As illustrated in FIG. 3, the containing member 48 includes a body member 50 that is open on the near side in the apparatus depth direction (the left side in FIG. 3) and a closing member 52 that closes an opening 50B of the body member 50.

The body member 50 includes a cylinder portion 54 that has a cylindrical shape extending in the apparatus depth direction and a closing portion 56 that closes the cylinder portion 54 on the far side in the apparatus depth direction (the right side in FIG. 3). In the body member 50, a containing portion 50A that has a columnar shape or a substantially columnar shape extending in the apparatus depth direction (an example of one direction) is formed and in which the toner T is contained.

In addition, a discharge port 54A through which the toner T, which is contained in the containing portion 50A, is discharged to a communication path (not illustrated) that communicates with the developing device 34 (see FIG. 6) is formed in a portion of the cylinder portion 54 on the far side in the apparatus depth direction. The discharge port 54A is positioned in such a manner as to face downward, and the toner T is to be discharged from the cylinder portion 54 in a downward direction.

An opening and closing lid 58 that opens and closes the discharge port 54A is attached to the discharge port 54A. In the case where the powder container 40 is removed from the apparatus body 10A (see FIG. 6), the opening and closing lid 58 is located at a closed position at which the opening and closing lid 58 closes the discharge port 54A by an urging force of an urging member (not illustrated). On the other hand, in the case where the powder container 40 is mounted in the apparatus body 10A, the opening and closing lid 58 is located at an open position at which the opening and closing lid 58 opens the discharge port 54A as a result of being pressed by a protrusion (not illustrated).

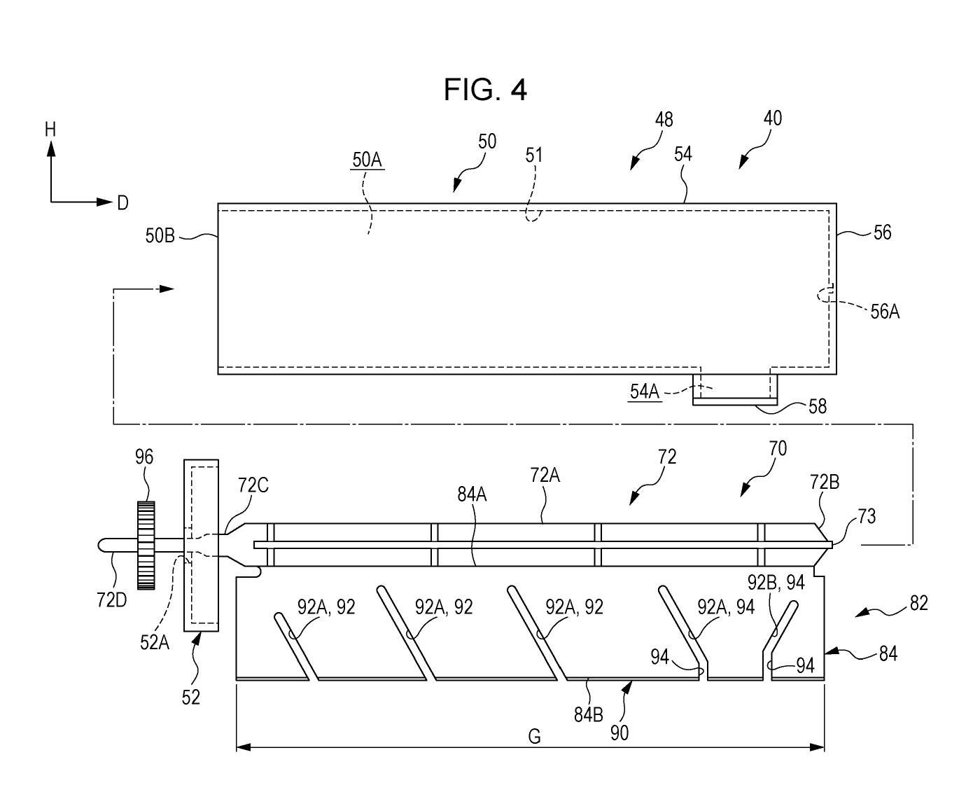

The closing portion 56 has a circular plate-like shape, and as illustrated in FIG. 4, a recess 56A is formed in a portion of an inner surface of the closing portion 56 positioned around the center of the inner surface of the closing portion 56. A protrusion 73 of a shaft portion 72, which will be described later, is inserted into the recess 56A, so that the recess 56A supports the shaft portion 72.

The closing member 52 has a circular plate-like shape, and a flange is formed over an outer peripheral portion of the closing member 52. The closing member 52 is fixed onto the opening 50B of the body member 50 by a fixing unit (not illustrated). In addition, a through hole 52A extending through the closing member 52 is formed in a portion of the closing member 52 around the center of the closing member 52. An intermediate portion 72C of the shaft portion 72, which will be described below, extends through the through hole 52A, so that the closing member 52 supports the shaft portion 72.

### [Transport Member]

As illustrated in FIG. 3 and FIG. 4, the transport member 70 includes the shaft portion 72 extending in the apparatus depth direction and a blade portion 82 that is fixed to the shaft portion 72. In the present exemplary embodiment, the shaft portion 72 and the blade portion 82 are integrally formed by injection molding using a polypropylene resin. The bending modulus of elasticity of the polypropylene resin is set to be 1,000 MPa as an example.

### [Shaft Portion]

The shaft portion 72 extends in the apparatus depth direction and is cross-shaped when viewed in cross section. The shaft portion 72 includes a body portion 72A and a distal end portion 72B. The body portion 72A has a constant cross section in the longitudinal direction, and the distal end portion 72B is tapered and formed in a portion of the body portion 72A on the far side in the apparatus depth direction. In addition, the protrusion 73 having a columnar shape is formed on an end of the distal end portion 72B.

The shaft portion 72 further includes the intermediate portion 72C and a proximal end portion 72D. The intermediate portion 72C is formed in a portion of the body portion 72A on the near side in the apparatus depth direction and has an external size smaller than that of the body portion 72A. The proximal end portion 72D is formed in a portion of the intermediate portion 72C on the near side in the apparatus depth direction and has an external size smaller than that of the intermediate portion 72C.

In this configuration, in a state where the transport member 70 is disposed in the containing member 48, the transport member 70 is supported by the containing member 48 in such a manner as to be rotatable while the shaft portion 72 is serving as the rotation axis of the transport member 70 as a result of the protrusion 73 being received in the recess 56A, and as a result of the intermediate portion 72C extending through the through hole 52A.

Note that a seal member (not illustrated) is provided in order to prevent the toner T from leaking to outside the containing member 48 from a gap between the intermediate portion 72C and the edge of the through hole 52A.

### [Blade Portion]

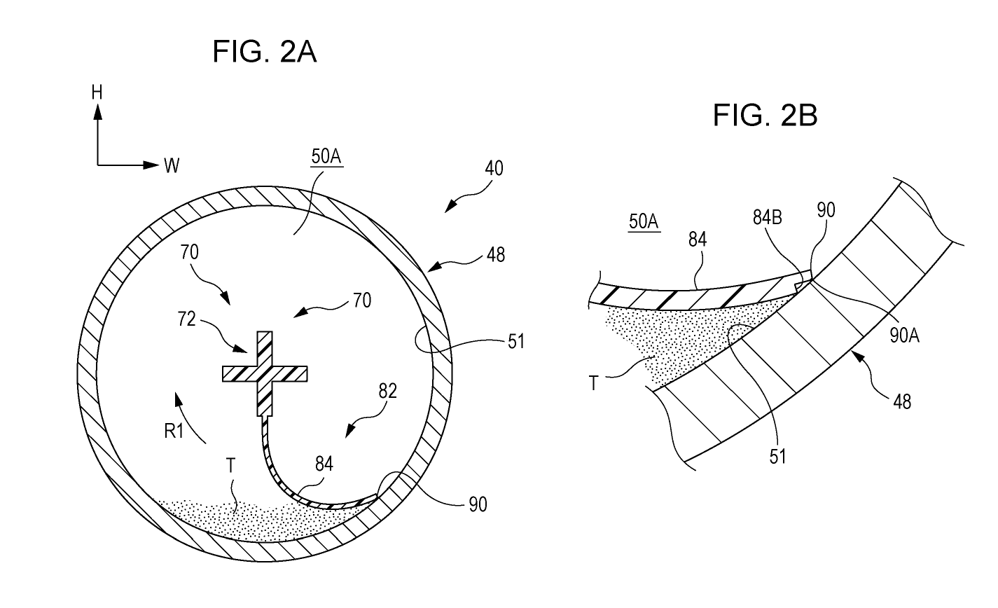

The blade portion 82 includes a body portion 84 that has a plate-like shape or a substantially plate-like shape (see FIGS. 2A and 2B) and a protruding portion 90 that is formed on a distal end 84B of the body portion 84. A proximal end 84A of the body portion 84 is fixed to the body portion 72A of the shaft portion 72, and the distal end 84B of the body portion 84 is bent by coming into contact with an inner wall 51 of the containing portion 50A.

In a state (free state) where the transport member 70 is not disposed in the containing member 48, the body portion 84 has a rectangular shape extending in the apparatus depth direction (an axial direction of the shaft portion 72), and a plate surface of the body portion 84 is oriented in the circumferential direction of the shaft portion 72. In addition, slits 92, which will be described later, are formed in the body portion 84 (blade portion 82).

In the present exemplary embodiment, the plate thickness (thickness T1 in FIG. 1B) of the proximal end 84A of the body portion 84 is 0.3 mm, and the plate thickness (thickness T2 in FIGS. 1B and 1D) of the distal end 84B of the body portion 84 is 0.15 mm.

As illustrated in FIGS. 1A and 1B, the protruding portion 90 protrudes from the distal end 84B of the body portion 84 in the radial direction of the shaft portion 72. In addition, the protruding portion 90 is formed over the entirety of the distal end 84B of the body portion 84 from the far side to the near side in the apparatus depth direction (region G in FIG. 4). Furthermore, as illustrated in FIG. 1D, the protruding portion 90 protrudes from one end of the body portion 84 in a plate thickness direction of the body portion 84.

The plate thickness (thickness T3 in FIG. 1C) of the protruding portion 90 is smaller than the plate thickness of the body portion 84 and is 0.005 mm or larger and 0.1 mm or smaller in the present exemplary embodiment. Note that, considering the mechanical strength and the flexibility of the protruding portion 90, the plate thickness of the protruding portion 90 is preferably 0.005 mm or larger and 0.05 mm or smaller and is more preferably 0.01 mm or larger and 0.03 mm or smaller.

The length (length L1 in FIG. 1D) of the protruding portion 90 is 0.05 mm or larger and 10.0 mm or smaller.

When the protruding portion 90 is viewed from the plate thickness direction of the blade portion 82, an end edge 90A of the protruding portion 90 has a wave-like shape or a substantially wave-like shape as illustrated in FIG. 1C. In the present exemplary embodiment, at the end edge 90A of the protruding portion 90, 20 or more protruding portions each having a wave-like shape or a substantially wave-like shape are formed in an area having a length of 1 mm in the apparatus depth direction. The range of the length of the protruding portion 90, which is the difference between a maximum protrusion amount and a minimum protrusion amount in one transport member 70 (distance Z in FIG. 1C), is 0.03 mm or larger and 0.1 mm or smaller.

Note that the dimensions and the shape of the protruding portion 90 may be measured by using, for example, a measuring microscope manufactured by Mitutoyo Corporation.

As illustrated in FIG. 4, the plural slits 92 are formed in the blade portion 82. In the free state, the plural slits 92 are inclined with respect to the radial direction of the shaft portion 72. The slits 92 divide the blade portion 82 into plural portions in the apparatus depth direction.

More specifically, the slits 92 include slits 92A and a slit 92B. In a state where the transport member 70 is disposed in the containing member 48, the slits 92A are positioned on the near side in the apparatus depth direction with respect to the discharge port 54A, and the slit 92B is positioned on the far side in the apparatus depth direction with respect to the discharge port 54A.

The plural slits 92A are formed at a predetermined pitch in the apparatus depth direction, and each of the slits 92A is inclined in such a manner that the distal end of the slit 92A (an end of the slits 92A that is farther from the shaft portion 72) is positioned further than the proximal end of the slit 92A (an end of the slit 92A that is closer to the shaft portion 72) toward the far side in the apparatus depth direction. On the other hand, the slit 92B is inclined in such a manner that the distal end of the slit 92B is positioned further than the proximal end of the slit 92B toward the near side in the apparatus depth direction.

Slits 94 extending in the radial direction of the shaft portion 72 are formed in such a manner that an end of one of the slits 92A that is positioned further than the rest of the slits 92A toward the far side in the apparatus depth direction and an end of the slit 92B are each connected to a corresponding one of the slits 94.

In this configuration, as illustrated in FIG. 2A, when the transport member 70 is rotated in the direction of arrow R1 in FIG. 2A in a state where the transport member 70 is disposed in the containing member 48, the blade portion 82 (body portion 84) is curved, and the transport member 70 rotates. Then, as illustrated in FIG. 5, the distal end 84B of the body portion 84 that is in contact with the inner wall 51 of the containing portion 50A is inclined with respect to the apparatus depth direction, so that the transport member 70, which rotates, transports the toner T contained in the containing portion 50A toward the discharge port 54A. As illustrated in FIGS. 2A and 2B, the direction of rotation of the transport member 70 is set in such a manner that the protruding portion 90 protrudes from a downstream portion of the distal end 84B of the body portion 84 in the direction of rotation of the transport member 70.

### [Others]

As illustrated in FIG. 5, a gear 96 is attached to the proximal end portion 72D of the shaft portion 72 that is exposed to the outside from the containing member 48.

In this configuration, in a state where the powder container 40 is mounted in the apparatus body 10A, the gear 96 and a gear (not illustrated) that is disposed in the apparatus body 10A engage with each other. Then, a force that causes the transport member 70 to rotate is transmitted from a driving source (not illustrated) to the transport member 70 via the gear 96, and the transport member 70 rotates.

### [Effects]

Effects of the powder container 40 will now be described by describing an operation of transporting the toner T contained in the containing portion 50A toward the discharge port 54A.

Once the force that causes the transport member 70 to rotate has been transmitted from the driving source (not illustrated) to the transport member 70 via the gear 96, as illustrated in FIGS. 2A and 2B, the transport member 70 rotates in the direction of arrow R1 (clockwise direction) while the body portion 84 is bent as a result of the distal end 84B of the body portion 84 coming into contact with the inner wall 51 of the containing portion 50A. Then, the transport member 70, which rotates, transports the toner T contained in the containing portion 50A toward the discharge port 54A (see FIG. 5).

Here, the protruding portion 90 is formed on the distal end 84B of the body portion 84. Thus, as illustrated in FIG. 2B, the distal end 84B of the body portion 84 and the protruding portion 90 are in contact with the inner wall 51 of the containing portion 50A.

When the protruding portion 90 is viewed from the plate thickness direction of the blade portion 82, the end edge 90A of the protruding portion 90 has a wave-like shape or a substantially wave-like shape (see FIG. 1C).

In the powder container 40, the protruding portion 90 protrudes from the downstream portion of the distal end 84B of the body portion 84 in the direction of rotation of the transport member 70 (see FIG. 2B). Thus, the distal end 84B of the body portion 84 and the end edge 90A of the protruding portion 90 come into contact with the inner wall 51 of the containing portion 50A.

Note that although a specific exemplary embodiment of the present invention has been described in detail, the present invention is not limited to the exemplary embodiment, and it is obvious to those skilled in the art that the present invention may employ other various exemplary embodiments within the scope of the present invention. For example, when the protruding portion 90 is viewed from the plate thickness direction of the blade portion 82, although the end edge 90A of the protruding portion 90 has a wave-like shape or a substantially wave-like shape in the above-described exemplary embodiment, the end edge 90A of the protruding portion 90 may have a linear shape. However, in this case, the effect achieved by forming the end edge 90A of the protruding portion 90 into a wave-like shape or a substantially wave-like shape will not occur.

In addition, although the protruding portion 90 protrudes from the downstream portion of the distal end 84B of the body portion 84 in the direction of rotation of the transport member 70 in the above-described exemplary embodiment, the protruding portion 90 may protrude from, for example, an upstream portion of the distal end 84B of the body portion 84 in the direction of rotation of the transport member 70. However, in this case, the effect achieved by forming the protruding portion 90 such that the protruding portion 90 protrudes from the downstream portion of the distal end 84B of the body portion 84 in the direction of rotation of the transport member 70 will not occur.

Furthermore, although the gear 96 is disposed on the near side in the apparatus depth direction with respect to the containing member 48 in the above-described exemplary embodiment, the gear 96 may be disposed on the far side in the apparatus depth direction with respect to the containing member 48.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A transport member comprising:
a shaft portion that extends in one direction and that is disposed in a containing portion, which has a substantially columnar shape extending in the one direction and contains a powder; and
a blade portion that includes a body portion having a substantially plate-like shape, a protruding portion having a plate thickness smaller than a plate thickness of the body portion, and a plurality of slits that extend to the protruding portion,
the body portion having a proximal end, which is fixed to the shaft portion, and a distal end, which is bent by coming into contact with an inner wall of the containing portion, and the protruding portion protruding from the distal end of the body portion.

2. The transport member according to claim 1,
wherein, when viewed from a plate thickness direction of the blade portion, an end edge of the protruding portion has a substantially wave-like shape.

3. A powder container comprising:
a containing member in which a containing portion, which has a substantially columnar shape extending in one direction and contains a powder, is formed and that has a discharge port, which is formed in one end portion of the containing member in the one direction and through which the powder contained in the containing portion is discharged; and
the transport member according to claim 1 that is rotatably supported by the containing member and that transports the powder contained in the containing portion toward the discharge port as a result of rotating.

4. A powder container comprising:
a containing member in which a containing portion, which has a substantially columnar shape extending in one direction and in which a powder is contained, is formed and that has a discharge port, which is formed in one end portion of the containing member in the one direction and through which the powder contained in the containing portion is discharged; and
the transport member according to claim 2 that is rotatably supported by the containing member and that transports the powder contained in the containing portion toward the discharge port as a result of rotating.

5. The powder container according to claim 3,
wherein the body portion is bent by coming into contact with the inner wall of the containing portion in such a manner that a portion of the body portion between the proximal end and the distal end of the body portion has a curved shape, and
wherein the protruding portion protrudes from a portion of the distal end of the body portion.

6. The powder container according to claim 4,
wherein the body portion is bent by coming into contact with the inner wall of the containing portion in such a manner that a portion of the body portion between the proximal end and the distal end of the body portion has a curved shape, and
wherein the protruding portion protrudes from a downstream portion of the distal end of the body portion.

7. An image forming apparatus comprising:
the powder container according to claim 3;
an image carrier on which an electrostatic latent image is to be formed; and
a developing unit that receives a toner, which is a powder discharged from the powder container, and develops the electrostatic latent image, which is formed on the image carrier, into a toner image.

8. An image forming apparatus comprising:
the powder container according to claim 4:
an image carrier on which an electrostatic latent image is formed; and
a developing unit that receives a toner, which is a powder discharged from the powder container, and develops the electrostatic latent image, which is formed on the image carrier, into a toner image.

9. An image forming apparatus comprising:
the powder container according to claim 5;
an image carrier on which an electrostatic latent image is formed; and
a developing unit that receives a toner, which is a powder discharged from the powder container, and develops the electrostatic latent image, which is formed on the image carrier, into a toner image.

10. An image forming apparatus comprising:
the powder container according to claim 6;
an image carrier on which an electrostatic latent image is formed; and
a developing unit that receives a toner, which is a powder discharged from the powder container, and develops the electrostatic latent image, which is formed on the image carrier, into a toner image.

11. The transport member according to claim 1, wherein the plurality of slits are inclined with respect to the radial direction of the shaft portion.

12. The transport member according to claim 11, wherein one of the plurality of slits is inclined with respect to the radial direction of the shaft in a different direction from a direction of incline of the other of the plurality of slits.
